(19) United States
(12) Patent Application Publication
(10) Pub. No.: US 2007/0217139 A1
(43) Pub. Date: Sep. 20, 2007

(54) Compartmented computer case

(75) Inventor: Peter Lin, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: POWER COOLER ENTERPRISE CO., LTD.

(21) Appl. No.: 11/486,312

(22) Filed: Jul. 14, 2006

(30) Foreign Application Priority Data
Mar. 17, 2006 (TW) 095204498

(51) Int. Cl. G06F 1/16

(52) U.S. Cl. 361/683; 312/223.1; 174/50

(57) ABSTRACT

A computer case is surrounded by detachable front, rear, left, right, top, and bottom panels. Ventilation openings and fans are provided on the panels. The case is divided into an upper first compartment for mounting a circuit board section, a lower second compartment for mounting a power supply and a drive section. A plurality of recesses are provided on a plate dividing the first and second compartments such that wires and busses are adapted to pass to electrically interconnect components of the first compartment and that of the second compartment and communicate signals between them. The invention can facilitate heat removal during the computer operation and is easily assembly or disassembly.

### BACKGROUND OF THE INVENTION

1. Field of Invention

The present invention relates to computer case and more particularly to a compartmented computer case which is easily assembly and facilitates heat removal during the computer operation.

2. Related Art

A conventional computer case, as shown in a side elevation of FIG. 1, comprises a power supply P, a circuit board section, and a drive section. The power supply P is adapted to supply required power to both the circuit board section and the drive section. The circuit board section comprises a motherboard Ml, a CPU (central processing unit) M2, and a plurality of cards M3. The drive section comprises a hard disk drive E1, a CD-ROM drive E2, and a CD-RW burner E3.

However, components arranged in the prior case are not neat. Wires interconnecting the components are messy. Further, it is not easy to clean dust accumulated on IC (integrated circuit) chips of the motherboard since an internal space of the case is not compartmented. And in turn, it may hinder a disassembly of component(s) from the case. Furthermore, it does not help dissipate heat generated by the components during operation. To the worse, the computer may malfunction due to overheat.

Thus, it is desirable to provide a compartmented computer case in order to overcome the inadequacies of the prior art and contribute significantly to the advancement of the art.

### SUMMARY OF THE INVENTION

It is therefore an object of the present invention to provide a computer case divided into a plurality of compartments each having a plurality of components mounted therein based on its functionality so as to facilitate assembly or disassembly of same.

It is another object of the present invention to provide a computer case divided into a plurality of compartments each having a plurality of components mounted therein based on its functionality so as to facilitate heat removal during operation.

It is a further object of the present invention to provide a computer case divided into a plurality of compartments each having a plurality of components mounted therein based on its functionality so as to efficiently use the space of the case.

To achieve the above and other objects, the present invention provides a computer case comprising a frame, a front panel, a rear panel, a left panel, a right panel, a top panel, and a bottom panel wherein the frame is surrounded by the panels and a space defined by the frame is divided into a first compartment for mounting a circuit board section, and a second compartment for mounting a power supply and a drive section such that it is possible of preventing components of one compartment from being interfered by that of the other compartment while disassembling.

In one aspect of the present invention the second compartment is divided into a third compartment with the power supply mounted therein, and a fourth compartment with the drive section mounted therein.

In another aspect of the present invention the first compartment is provided on an upper portion of the frame and the second compartment is provided below the first compartment.

In yet another aspect of the present invention the first compartment is separated from the second compartment by a plate including a plurality of recesses for permitting wires and busses to pass to electrically interconnect components of the first compartment and that of the second compartment and communicate signals between them.

In a further aspect of the present invention ventilation is the primary consideration in customizing the first compartment since the circuit board section including a motherboard, a CPU, and a plurality of cards are mounted therein.

In yet further aspect of the present invention ventilation is the primary consideration in customizing the third compartment since the power supply is mounted therein.

The above and other objects, features and advantages of the present invention will become apparent from the following detailed description taken with the accompanying drawings.

### BRIEF DESCRIPTION OF THE DRAWINGS

FIG. 1 is a side elevation of a conventional computer case;

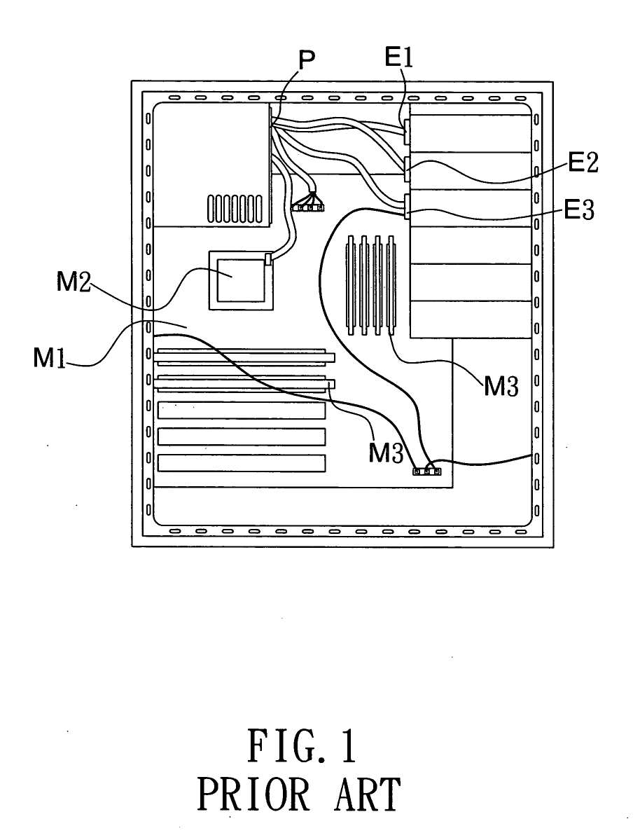

FIG. 2 is a perspective view of a preferred embodiment of the frame of a compartmented computer case according to the invention to be assembled with computer components;

FIG. 3 is a perspective view of the frame of the case with the components assembled therein; and

FIG. 4 is a perspective view of the mounted components and the frame of the case to be assembled with a plurality of panels.

### DETAILED DESCRIPTION OF THE INVENTION

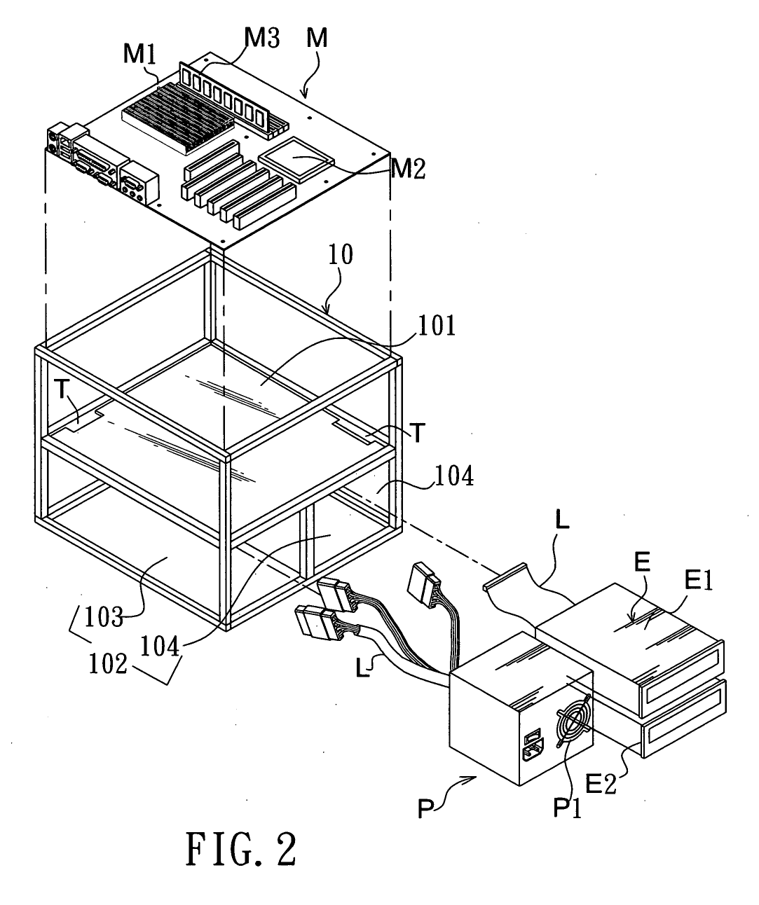

Referring to FIGS. 2, 3, and 4, a computer case 10 in accordance with a preferred embodiment of the invention is shown. The case 10 comprises a plurality of compartments 101, 103, and 104 each adapted to mount a power supply P having a fan P1; a circuit board section M including a motherboard M1, a CPU M2; and a plurality of cards M3; and a drive section E including a hard disk drive E1, a CD-ROM drive E2, or the like, respectively.

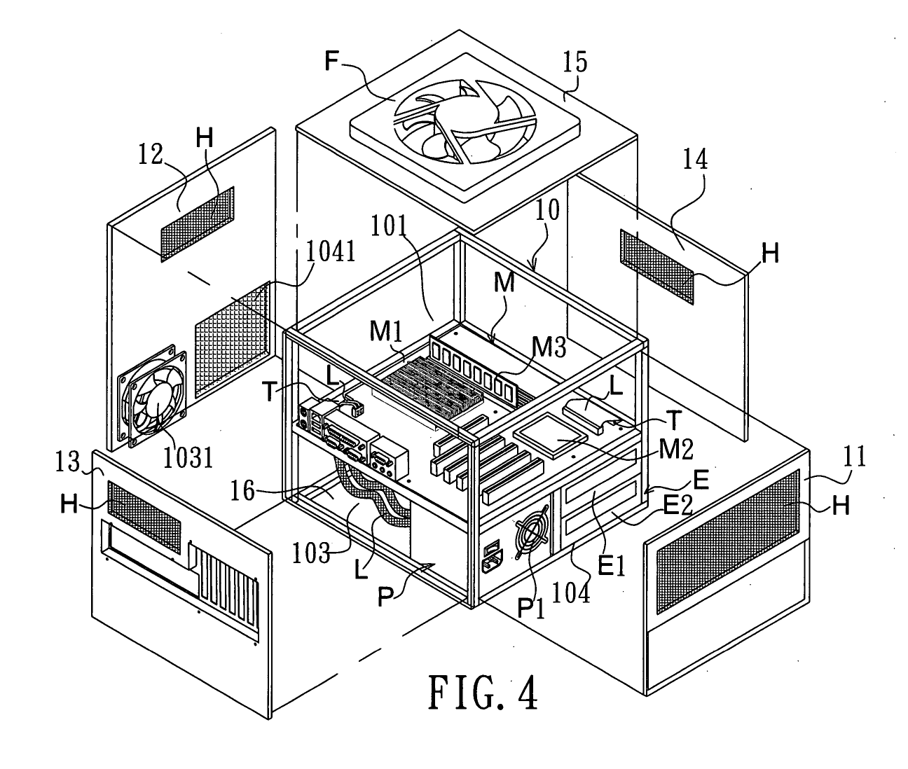

Referring to FIG. 4 again, a parallelepiped frame of the case 10 is surrounded by a front panel 11 having a ventilation opening H, a rear panel 12 having a ventilation opening H, a left panel 13 having a ventilation opening H, a right panel 14 having a ventilation opening H, a top panel 15, and a bottom panel 16. An internal space of the case 10 is divided into two independent compartments including a first compartment 101 and a second compartment 102. The first compartment 101 is adapted to mount the circuit board section M including the motherboard M1, the CPU M2, and the cards M3 therein. Hence, ventilation is the primary consideration in customizing the first compartment 101. Preferably, the first compartment 101 is provided on an upper portion of the case 10. That is, the first compartment 101 is surrounded by the front panel 11, the rear panel 12, the left panel 13, the right panel 14, and the top panel 15. Heat generated by the circuit board section M can be completely dissipated through the ventilation openings H during operation. Further, a large fan F is provided on a top of the top panel 15. The fan F is adapted to generate air flow into the first compartment 101 to cool the components of the circuit board section M. As a result, hot air successfully exits from the ventilation openings H of the front panel 11, the rear panel 12, the left panel 13, and the right panel 14.

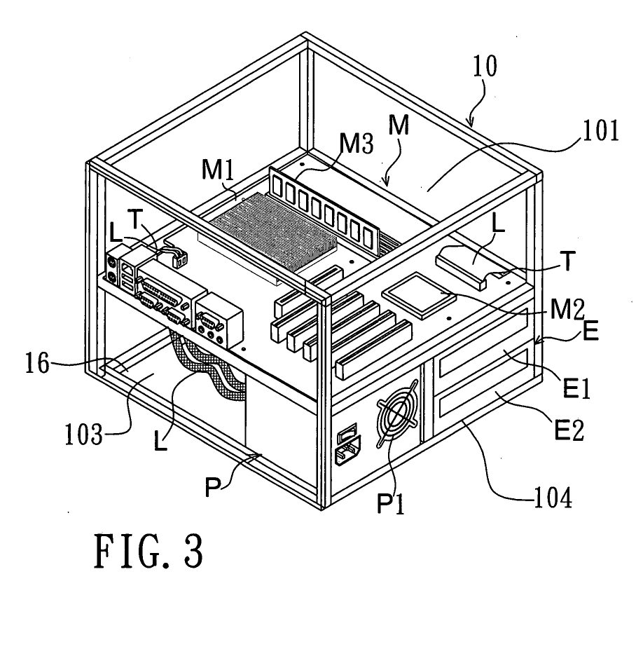

Referring to FIG. 2 again, the second compartment 102 is provided below the first compartment 101 in the embodiment and is comprised of a third compartment 103 and a fourth compartment 104. The power supply P is provided in the third compartment 103. Ventilation is the primary consideration in customizing the third compartment 103 since the power supply P already has a fan P1 which is adapted to quickly dissipate heat generated by the power supply P. Moreover, a fan 1031, as shown in FIG. 3, is provided on the rear panel 12 and is disposed opposing the power supply P. The fan 1031 is adapted to enhance a removal of heat generated by the power supply P out of the case 10.

The drive section E is mounted in the fourth compartment 104. Heat generated by the drive section E is not as high as other components described above. Thus, an installation of a fan is optional. A ventilation opening 1041 is provided on the rear panel 12 (see FIG. 4). Alternatively, a ventilation opening (not shown) may be provided on a dividing wall between the third compartment 103 and the fourth compartment 104. Thus, heat generated by the drive section E may be transferred to the third compartment 103 prior to removing out of the third compartment 103 through the fan 1031.

Wires and busses L are provided for electrically interconnecting the components and communicating signals between them. A plurality of recesses T are provided on a plate dividing the first compartment 101 and the second compartment 102. The wires and busses L are adapted to pass the recesses T to electrically interconnect the components between any two adjacent compartments and communicate signals between them. A user may detach one or more panels surrounding a compartment with malfunctioned component(s) mounted therein prior to removing same for repair or replacing same with new one(s). This has the benefit of preventing components in other compartments from being damaged or interfered during the maintenance.

In brief, an optimization of an internal space of a computer case is made possible by the invention since computer components are mounted in respective compartments based on its functionality. This further has the benefit of facilitating maintenance. Furthermore, heat removal is complete during operation since the case is divided into at least two compartments based on functionalities of the components.

While the invention herein disclosed has been described by means of specific embodiments, numerous modifications and variations could be made thereto by those skilled in the art without departing from the scope and spirit of the invention set forth in the claims.

What is claimed is:

1. A computer case comprising a frame, a front panel, a rear panel, a left panel, a right panel, a top panel, and a bottom panel, wherein the frame is surrounded by the panels and a space defined by the frame is divided into a first compartment for mounting a circuit board section, and a second compartment for mounting a power supply and a drive section.

2. The computer case of claim 1, wherein the second compartment is further divided into a third compartment with the power supply mounted therein, and a fourth compartment with the drive section mounted therein.

3. The computer case of claim 1, wherein the first compartment is provided on an upper portion of the frame.

4. The computer case of claim 1, wherein the second compartment is provided below the first compartment.

5. The computer case of claim 1, wherein the first compartment is separated from the second compartment by a plate including a plurality of recesses for permitting wires. and busses to pass to electrically interconnect components of the first compartment and that of the second compartment and communicate signals between them.
